(19) United States
(12) Patent Application Publication
(10) Pub. No.: US 2024/0380962 A1
(43) Pub. Date: Nov. 14, 2024

(54) VIEWING OPTIC WITH DIGITAL IMAGE CAPTURE FUNCTION

(71) Applicant: Sheltered Wings, Inc. d/b/a Vortex Optics, Barneveld, WI (US)

(72) Inventor: Todd Clermont, Barneveld, WI (US)

(21) Appl. No.: 18/660,397

(22) Filed: May 10, 2024

Related U.S. Application Data
(60) Provisional application No. 63/501,459, filed on May 11, 2023.

(51) Int. Cl. H04N 23/55; G02B 23/06; H04N 23/60

(52) U.S. Cl. CPC H04N 23/55; G02B 23/06; H04N 23/64

(57) ABSTRACT

The disclosure relates to viewing optics. In one embodiment, the disclosure relates to viewing optics including image capture capabilities. In another embodiment, the disclosure relates to binoculars or a sighting scope having selectively enabled image capture capabilities.

### CROSS-REFERENCE TO RELATED APPLICATIONS

This application claims priority to and is a non-provisional patent application of U.S. Provisional Patent Application No. 63/501,459 filed May 11, 2023, which is incorporated herein by reference in its entirety.

### FIELD

The disclosure relates to optical devices. In one embodiment, the disclosure relates to a viewing optic having the ability to capture digital images.

### BACKGROUND

Existing viewing optics magnify distant objects, thereby allowing a user to see an object clearly even when located far away from the object. For example, a birdwatcher can use binoculars to spot a rare bird high up in a tall tree even when the viewer is located on the ground. However, if the viewer wants to capture an image of the rare bird, the viewer would need to put down the binoculars and use a digital camera, camera phone, or other image capturing device, different than the binoculars, to capture the image. In some circumstances, the viewer will lose the photo opportunity or have difficulty finding the distant object again using a new device. Even if the viewer is able to relocate the rare bird or other distant object, the digital camera may have different optical quality or zoom capabilities, resulting in a lower quality image, even if captured.

Therefore, it would be desirable to provide a system where viewers can capture photos with a viewing optic, thereby eliminating the need to switch optical devices.

### SUMMARY

In one embodiment, the disclosure relates to a viewing optic having image capture capabilities. In one embodiment, the viewing optic is a binocular. In one embodiment, the viewing optic is a spotting scope. In one embodiment, the viewing optic is a monocular.

In one embodiment, the disclosure relates to a viewing optic comprising a first barrel having: at least one first objective lens; at least one first ocular lens; at least one first prism; an image sensor configured to capture an image; and a redirection lens configured to selectively redirect a first light beam toward the image sensor in response to a first command; and a second barrel comprising: at least one second objective lens; at least one second ocular lens; at least one second prism.

In one embodiment, the disclosure relates to a viewing optic having at least one first objective lens; at least one first ocular lens; at least one first prism; an image sensor configured to capture an image; and a redirection lens configured to selectively redirect a first light beam toward the image sensor in response to a first command.

In another embodiment, the disclosure relates to a method comprising capturing a light beam using optical elements of a viewing optic and delivering the light beam to a viewer's eye via a primary optical path, receiving a command from a user to capture an image, redirecting the light beam with a redirection lens toward a secondary optical path toward an image sensor response to receiving the command, capturing an image with an image sensor based on the light beam, and using the redirection lens to allow the light beam to again pass to the user's eye along the primary optical path after the image sensor captures the image.

Other embodiments will be evident from a consideration of the drawings taken together with the detailed description provided herein.

### BRIEF DESCRIPTION OF THE DRAWINGS

FIG. 1 is a representative illustration of binoculars having a digital image sensor, in accordance with embodiments of the disclosure.

FIGS. 2A and 2B are representative illustrations of a spotting scope having a digital image sensor, in accordance with embodiments of the disclosure.

FIG. 3 illustrates a method of using a viewing optic to capture an image, in accordance with embodiments of the disclosure.

### DETAILED DESCRIPTION

The assemblies, apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a stationary platform, such as a bipod, tripod, and other permutations of stationary platforms. Further, it will be appreciated by those skilled in the art that the various features and/or capabilities described herein may be deployed in various industries, including shooting, photography, surveying, and other areas in which a stable stationary platform is desired to secure a viewing optic, firearm, sight, camera, and other such device.

### Definitions

Like numbers refer to like elements throughout. It will be understood that, although the terms first, second, etc., may be used herein to describe various elements, components, regions, and/or sections, these elements, components, regions and/or sections should not be limited by these terms. These terms are used only to distinguish one element, component, region and/or section from another element, component, region and/or section. Thus, a first element, component, region or section could be termed a second element, component, region or section without departing from the disclosure.

The numerical ranges in this disclosure are approximate, and thus may include values outside of the range unless otherwise indicated. Numerical ranges include all values from and including the lower and the upper values (unless specifically stated otherwise), in increments of one unit, provided that there is a separation of at least two units between any lower value and any higher value. As an example, if a compositional, physical or other property, such as, for example, distance, speed, velocity, etc., is from 10 to 100, it is intended that all individual values, such as 10, 11, 12, etc., and sub ranges, such as 10 to 44, 55 to 70, 97 to 100, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

Spatial terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the term “and/or” includes any and all combinations of one or more of the associated listed items. For example, when used in a phrase such as “A and/or B,” the phrase “and/or” is intended to include both A and B; A or B; A (alone); and B (alone). Likewise, the term “and/or” as used in a phrase such as “A, B and/or C” is intended to encompass each of the following embodiments” A, B and C; A, B, or C; A or C; A or B; B or C; A and C; A and B; B and C; A (alone); B (alone); and C (alone).

It will be understood that when an element or layer is referred to as being “on,” “connected to” or “coupled to” another element or layer, it can be directly on, connected or coupled to the other element or layer. Alternatively, intervening elements or layers may be present. In contrast, when an element or layer is referred to as being “directly on,” “directly connected to” or “directly coupled to” another element or layer, there are no intervening elements or layers present.

As used herein, the terms “user” and “shooter” interchangeably refer to either the operator making the shot or an individual observing the shot in collaboration with the operator making the shot.

As used herein, the term “viewing optic” refers to an apparatus or assembly used by a user, a shooter or a spotter to select, identify and/or monitor a target. A viewing optic may rely on visual observation of the target or, for example, on infrared (IR), ultraviolet (UV), radar, thermal, microwave, magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to a user/shooter/spotter by a viewing optic may be unaltered, or it may be enhanced, for example, by magnification, amplification, subtraction, superimposition, filtration, stabilization, template matching, or other means. The target selected, identified and/or monitored by a viewing optic may be within the line of sight of the shooter or tangential to the sight of the shooter. In other embodiments, the shooter's line of sight may be obstructed while the viewing optic presents a focused image of the target. The image of the target acquired by the viewing optic may, for example, be analog or digital, and shared, stored archived or transmitted within a network of one or more shooters and spotters by, for example, video, physical cable or wire, IR, radio wave, cellular connections, laser pulse, optical 802.11b or other wireless transmission using, for example, protocols such as html. SML, SOAP, X.25, SNA, etc., Bluetooth™, Serial, USB or other suitable image distribution method. The term “viewing optic” is used interchangeably with “optic sight.”

As used herein, a “firearm” is a portable gun, being a barreled weapon that launches one or more projectiles often driven by the action of an explosive force. As used herein, the term “firearm” includes a handgun, a long gun, a rifle, shotgun, a carbine, automatic weapons, semi-automatic weapons, a machine gun, a sub-machine gun, an automatic rifle and an assault rifle.

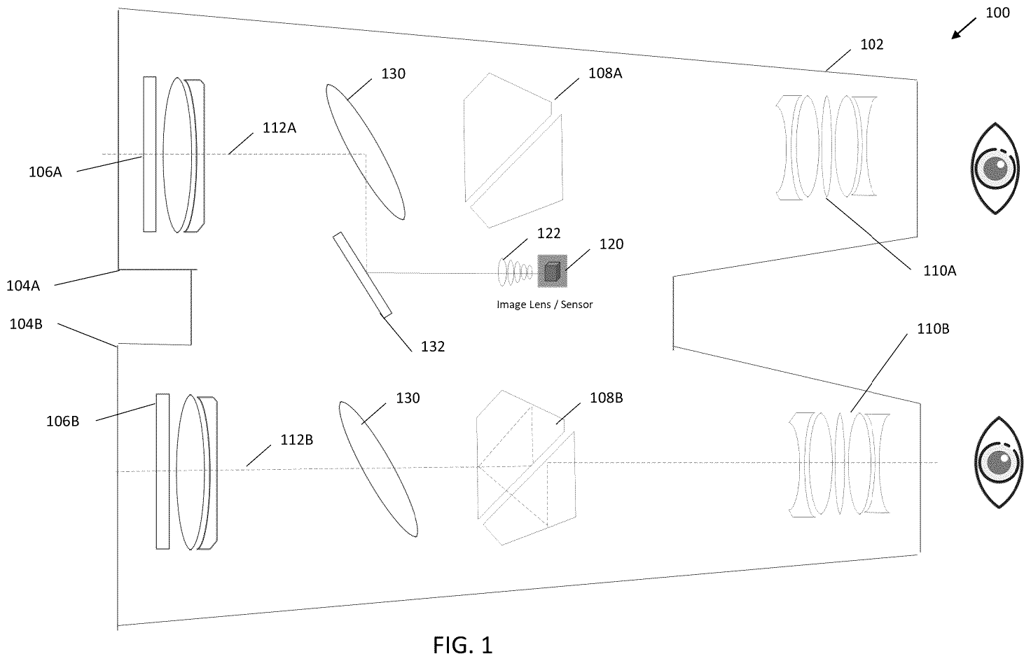

FIG. 1 is a block diagram of binoculars 100 as the viewing optic having image capture capabilities. In the embodiment shown, the binoculars 100 includes a housing 102 having a first barrel 104A and a second barrel 104B. In general, the first barrel 104A has the same or similar optical components as the second barrel 104B with one notable exception described in greater detail below. That is, the first barrel 104A can include first objective lenses 106A, first prisms 108A, and first ocular lenses 110A, and the second barrel 104B can include second objective lenses 106B, second prisms 108B, and second ocular lenses 110B. The first and second objective lenses 106, 106B can generally comprise one or more convex lenses, and the objective lenses 106A, 106B can have an objective diameter, which can determine the brightness of the binoculars 100 as well as impact the weight of the binoculars 100. The first and second prisms 108A, 108B can respectively invert an image from the first and second objective lenses 106A, 106B because the first and second objective lenses 106A, 106B generate an upside-down image. The first and second prisms 108A, 108B can comprise porro, smidt, or pecan prisms, as necessary based on the objective lenses 106A, 106B or the design choices of the binoculars 100. In addition, the first and second ocular lenses 110A, 110B can magnify the respective optical beams 112A, 112B based on a focal length of the ocular lenses 110A, 110B. As will be understood by those of skill in the art, the housing 102, the first and second barrels 104A, 104B, the first and second objective lenses 106A, 106B, the first and second prisms 108A, 108B, and the first and second ocular lenses 110A, 110B operate the same or similarly as conventional optical elements found in conventional binoculars.

In addition, the exemplary embodiments described herein can further include an image sensor 120 and a microlens array 122. The image sensor 120 can comprise a CMOS or CCD image sensor, as will be understood by those of skill in the art. Additionally, the microlens array 122 can comprise one or more relatively small (e.g., a lens diameter less than 1 mm in size) lenses configured to focus and concentrate the first light beam 112A onto a surface of the image sensor 120 so that the image sensor 120 can accurately capture an image.

Additionally, the first barrel 104A can include a redirection lens 130 and a redirection mirror 132. The redirection lens 130 may selectively direct the first light beam 112A either toward the first prisms 108A or to the redirection mirror 132. During normal binocular use, such as when a user is looking for a rare bird or other target image, the redirection lens 130 may allow the first light beam 112A to continue straight toward the first prisms 108A and eventually to one of the user's eyes. Alternatively, the binoculars 100 of the exemplary embodiments can selectively redirect the first light beam 112A onto the image sensor 120 in response to the user submitting a command to capture an image. In some embodiments, the command may be in the form of a user pressing a shutter button on the housing 102 of the binoculars 100. Pressing the shutter button can cause the redirection lens 130 to divert the first light beam 112A toward the redirection mirror 132, and the redirection mirror 132 directs the first light beam 112A toward the microlens array 122 and ultimately the image sensor 120. After the image has been captured, the redirection lens 130 can allow the first light beam 112A to again travel straight toward the first prisms 108A and one of the user's eyes. In this way, the exemplary embodiments use an existing optical path of the binoculars 100 to capture an image, thereby ensuring that the image captured duplicates the image sighted by the user through the binoculars 100.

In an embodiment, only the first barrel 104A can include the image sensor 120 and the microlens array 122. Only one image sensor is needed to capture an image, so multiple image sensors may be unnecessary. Additionally, when the user presses the shutter button, the user may not be able to see the target image through the first barrel 104A, but the user may still be able to see the target image through the second barrel 104B because the second light beam 112B may constantly transmit from the second objective lenses 106B to the second ocular lenses 110B in the second barrel 104B. That is, only the first barrel 104A may be affected by the image capture command.

In another embodiment, the first barrel 104A and the second barrel 104B can include an image sensor and microlens array.

Although not illustrated, the binoculars 100 can further include a processor and memory. The processor can control the operations of the image sensor 120, and the processor can further receive electrical signals from the image sensor 120 to process the electrical signals and generate a digital image. Generating the digital image can further include autofocus operations and features. Upon generating the digital image, the processor can provide a digital signal indicative of the digital image and store the digital image in the memory. In an embodiment, the processor and the memory are included within or coupled to the image sensor 120. The binoculars 100 can further include wired and/or wireless communication interfaces so that the digital images stored in the memory can be transmitted to a separate device (e.g., computer, smartphone, tablet, etc.). The binoculars 100 can use any wireless medium, including Bluetooth, NFC, WiFi, LTE, or any other wireless medium. The binoculars can further include a wired connection port, such as a USB, firewire, Lightning, or any other wired connection port to connect the binoculars to the separate device via a wired connection. The wired or wireless connection can also configure image settings in the image sensor 120.

Additionally, although not illustrated, the image sensor 120 can further comprise image stabilization elements, such as axis gimble rotation in four or more axes. As will be understood by those having skill in the art, the image stabilization elements can ensure high quality images even when a user's hand is shaking while using the binoculars to sight distant images.

The binoculars 100 can further comprise a chassis formed between the first barrel 104A and the second barrel 104B that connects or holds together the first barrel 104A and the second barrel 104B. The chassis can include various conventional features of binoculars, including a focus wheel that moves the ocular lenses 110A, 110B closer to the objective lenses 106A, 106B so that the objective lenses 106A, 106B focal point match the ocular lenses 110A, 110B focal point. The chassis can further include a diopter adjustment ring to focus the image for the user's particular eyesight acuity.

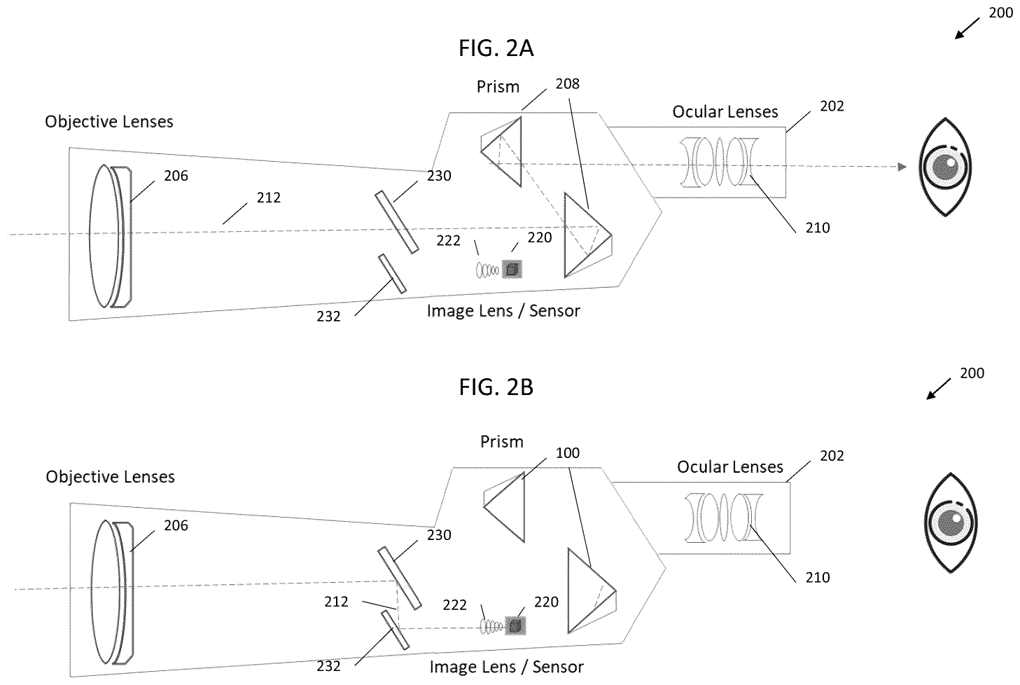

FIGS. 2A and 2B are block diagrams of a sighting scope 200 having image capture capabilities. In the embodiment shown, the sighting scope 200 includes a housing 202 having objective lenses 206A, prisms 208A, and ocular lenses 210A. The objective lenses 206 can generally comprise one or more convex lenses, and the objective lenses 206 can have an objective diameter, which can determine the brightness of the binoculars as well as impact the weight of the sighting scope 200. The prisms 208 can respectively invert an image from the objective lenses 206 because the objective lenses 206 generate an upside-down image. The prism 208 can comprise porro, smidt, or pecan prisms, as necessary based on the objective lenses 206 or the design choices of the sighting scope 200. In addition, the ocular lenses 210 can magnify the light beam 212 based on a focal length of the ocular lenses 210. As will be understood by those of skill in the art, the housing 202, the objective lenses 206, the prisms 208, and the ocular lenses 210 may function similarly to conventional optical elements found in conventional sighting scopes.

In addition, the exemplary embodiments described herein can further include an image sensor 220 and a microlens array 222. The image sensor 220 can comprise a CMOS or CCD image sensor, as will be understood by those of skill in the art. Additionally, the microlens array 222 can comprise one or more relatively small (e.g., a lens diameter less than 1 mm in size) lenses configured to focus and concentrate the light beam 212 onto a surface of the image sensor 220 so that the image sensor 220 can accurately capture an image.

Additionally, the sighting scope 200 can include a redirection lens 230 and a redirection mirror 232. The redirection lens 230 is configured to selectively direct the light beam 212 either toward the prisms 208 or to the redirection mirror 232. During normal sighting scope use, such as when a user is looking for a rare bird or other target image, the redirection lens 230 allows the first light beam 212 to continue straight toward the prisms 208 and eventually to one of the user's eyes. Alternatively, the sighting scope 200 of the exemplary embodiments can selectively redirect the light beam 212 onto the image sensor 220 in response to the user submitting a command to capture an image. In some embodiments, the command may be in the form of a user pressing a shutter button on the housing 202 of the sighting scope 200. Pressing the shutter button can cause the redirection lens 230 to divert the light beam 212 toward the redirection mirror 232, and the redirection mirror 232 directs the light beam 212 toward the microlens array 222 and ultimately the image sensor 220. After the image has been captured, the redirection lens 230 allows the light beam 212 to again travel toward the prisms 208 and one of the user's eyes. In this way, the exemplary embodiments use an existing optical path of the sighting scope 200 to capture an image, thereby ensuring that the image captured duplicates the image sighted by the user through the sighting scope 200. FIG. 2A illustrates the optical elements 206, 208, 210 transmitting the light beam 212 down a primary path toward the user's eye, whereas FIG. 2B illustrates the light beam 212 down a secondary path toward the image sensor 220.

Although not illustrated, the sighting scope 200 can further include a processor and memory. The processor can control the operations of the image sensor 220, and the processor can further receive electrical signals from the image sensor 220 to process the electrical signals and generate a digital image. Generating the digital image can further include autofocus operations and features. Upon generating the digital image, the processor can provide a digital signal indicative of the digital image and store the digital image in the memory. In an embodiment, the processor and the memory are included within or coupled to the image sensor 220. The sighting scope 200 can further include wired and/or wireless communication interfaces so that the digital images stored in the memory can be transmitted to a separate device (e.g., computer, smartphone, tablet, etc.). The sighting scope 200 can use any wireless medium, including Bluetooth, NFC, WiFi, LTE, or any other wireless medium. The binoculars can further include a wired connection port, such as a USB, firewire, Lightning, or any other wired connection port to connect the binoculars to the separate device via a wired connection. The wired or wireless connection can also configure image settings in the image sensor 220.

Additionally, although not illustrated, the image sensor 220 can further comprise image stabilization elements, such as axis gimble rotation in four or more axes. As will be understood by those having skill in the art, the image stabilization elements can ensure high quality images even when a user's hand is shaking while using the binoculars to sight distant images.

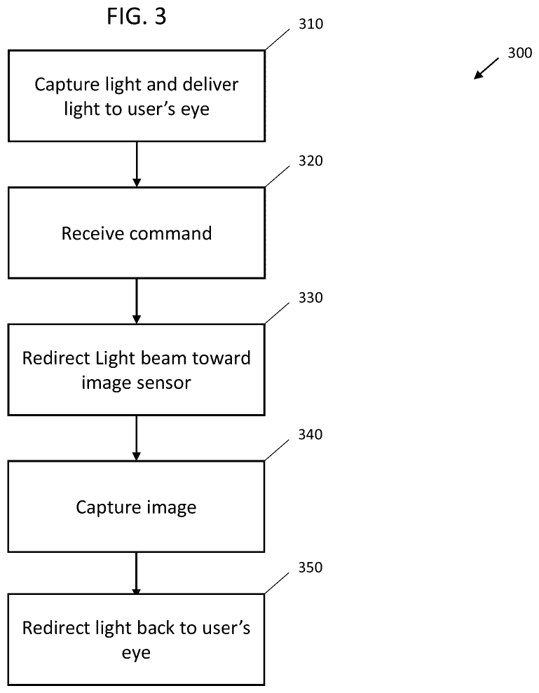

FIG. 3 illustrates a method 300 for redirecting a light beam to capture an image in a viewing optic, such as the binoculars 100 of FIG. 1 or the sighting scope 200 of FIGS. 2A and 2B. As shown, the method 300 can include a viewing optic capturing a light beam using optical elements and delivering the light beam to a viewer's eye via a primary optical path in step 310, and receiving a command from a user to capture an image in step 320. Receiving the command may comprise detecting that the user has pressed a shutter button on the viewing optic. In, the method 300 can include redirecting the light beam toward a secondary optical path toward an image sensor using a redirection lens in step 330. Once the light beam has been redirected, the image sensor can receive the light beam and capture an image based on received light in the light beam in step 340. After the image is captured, the method 300 can include the redirection lens allowing the light beam to again pass to the user's eye along the primary optical path in step 350.

While the exemplary embodiments described herein were described as capturing a single image, the exemplary viewing optics described here can also use the image sensors 120, 220 to capture video. Capturing video comprises the image sensor 120, 220 capturing multiple images in quick succession and processing the images into a moving picture file, as will be understood by those having skill in the art. Both the binoculars 100 and the sighting scope 200 can capture video. The disclosure is now further described by the following paragraphs:
1. A viewing optic comprising: a first barrel comprising: at least one first objective lens; at least one first ocular lens; at least one first prism; an image sensor configured to capture an image; and a redirection lens configured to selectively redirect a first light beam toward the image sensor in response to a first command; and
a second barrel comprising: at least one second objective lens; at least one second ocular lens; and at least one second prism.
2. The viewing optic of paragraph 1, further comprising a microlens array associated with the image sensor and configured to focus and concentrate the first light beam onto a surface of the image sensor so that the image sensor captures an image.
3. The viewing optic of any of the following paragraphs, further comprising a redirection mirror configured to receive the redirected first light beam from the redirection lens and reflect the first light beam toward the microlens array.
4. The viewing optic of any of the following paragraphs, wherein the redirection lens is further configured to allow the first light beam to pass toward the at least one first prism when the first command is not transmitted.
5. The viewing optic of any of the following paragraphs, further comprising a processor and memory.
6. The viewing optic of any of the following paragraphs, wherein the processor is configured to receive signals from the image sensor, generate the image from the signals, and store the image in the memory.
7. The viewing optic of any of the following paragraphs, further comprising a wired or wireless connection interface configured to transmit the image to a separate device in response to a second command from the processor.
8. The viewing optic of any of the following paragraphs, further comprising a shutter button formed on a chassis of the viewing optic, wherein a user pressing the shutter button generates the first command.
9. A viewing optic comprising: at least one first objective lens; at least one first ocular lens; at least one first prism; an image sensor configured to capture an image; and a redirection lens configured to selectively redirect a first light beam toward the image sensor in response to a first command.
10. The viewing optic of paragraph 9, further comprising a microlens array associated with the image sensor and configured to focus and concentrate the first light beam onto a surface of the image sensor so that the image sensor captures an image.
11. The viewing optic of any of the following paragraphs, further comprising a redirection mirror configured to receive the redirected first light beam from the redirection lens and reflect the first light beam toward the microlens array.
12. The viewing optic of any of the following paragraphs, wherein the redirection lens is further configured to allow the first light beam to pass toward the at least one first prism when the first command is not transmitted.
13. The viewing optic of any of the following paragraphs, further comprising a processor and memory.
14. The viewing optic of any of the following paragraphs, wherein the processor is configured to receive signals from the image sensor, generate the image from the signals, and store the image in the memory.
15. The viewing optic of any of the following paragraphs, further comprising a wired or wireless connection interface configured to transmit the image to a separate device in response to a second command from the processor.
16. The viewing optic of any of the following paragraphs, further comprising a shutter button formed on a chassis of the viewing optic, wherein a user pressing the shutter button generates the first command.
17. A method comprising: capturing a light beam using optical elements of a viewing optic and delivering the light beam to a viewer's eye via a primary optical path; receiving a command from a user to capture an image; redirecting the light beam with a redirection lens toward a secondary optical path toward an image sensor response to receiving the command; capturing an image based on the light beam with an image sensor; and using the redirection lens to allow the light beam to again pass to the user's eye along the primary optical path after the image sensor captures the image.

Various modifications and variations of the described structures, assemblies, apparatuses and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modifications are possible without departing from the scope of the invention as set forth in the appended claims. Indeed, various modifications of the described modes for carrying out the invention which are obvious to those skilled in marksmanship or related fields are intended to be within the scope of the following claims.

What is claimed is:

1. A viewing optic comprising:
a first barrel comprising:
at least one first objective lens;
at least one first ocular lens;
at least one first prism;
an image sensor configured to capture an image; and
a redirection lens configured to selectively redirect a first light beam toward the image sensor in response to a first command; and
a second barrel comprising:
at least one second objective lens;
at least one second ocular lens;
at least one second prism.

2. The viewing optic of claim 1, further comprising a microlens array associated with the image sensor and configured to focus and concentrate the first light beam onto a surface of the image sensor so that the image sensor captures an image.

3. The viewing optic of claim 2, further comprising a redirection mirror configured to receive the redirected first light beam from the redirection lens and reflect the first light beam toward the microlens array.

4. The viewing optic of claim 1, wherein the redirection lens is further configured to allow the first light beam to pass toward the at least one first prism when the first command is not transmitted.

5. The viewing optic of claim 1, further comprising a processor and memory.

6. The viewing optic of claim 5, wherein the processor is configured to receive signals from the image sensor, generate the image from the signals, and store the image in the memory.

7. The viewing optic of claim 5, further comprising a wired or wireless connection interface configured to transmit the image to a separate device in response to a second command from the processor.

8. The viewing optic of claim 1, further comprising a shutter button formed on a chassis of the viewing optic, wherein a user pressing the shutter button generates the first command.

9. A viewing optic comprising:
at least one first objective lens;
at least one first ocular lens;
at least one first prism;
an image sensor configured to capture an image; and
a redirection lens configured to selectively redirect a first light beam toward the image sensor in response to a first command.

10. The viewing optic of claim 9, further comprising a microlens array associated with the image sensor and configured to focus and concentrate the first light beam onto a surface of the image sensor so that the image sensor captures an image.

11. The viewing optic of claim 10, further comprising a redirection mirror configured to receive the redirected first light beam from the redirection lens and reflect the first light beam toward the microlens array.

12. The viewing optic of claim 9, wherein the redirection lens is further configured to allow the first light beam to pass toward the at least one first prism when the first command is not transmitted.

13. The viewing optic of claim 9, further comprising a processor and memory.

14. The viewing optic of claim 13, wherein the processor is configured to receive signals from the image sensor, generate the image from the signals, and store the image in the memory.

15. The viewing optic of claim 13, further comprising a wired or wireless connection interface configured to transmit the image to a separate device in response to a second command from the processor.

16. The viewing optic of claim 9, further comprising a shutter button formed on a chassis of the viewing optic, wherein a user pressing the shutter button generates the first command.

17. A method comprising:
capturing a light beam using optical elements of a viewing optic and delivering the light beam to a viewer's eye via a primary optical path;
receiving a command from a user to capture an image;
redirecting the light beam with a redirection lens toward a secondary optical path toward an image sensor response to receiving the command;
capturing an image with an image sensor based on the light beam; and
using the redirection lens to allow the light beam to again pass to the user's eye along the primary optical path after the image sensor captures the image.
